(19) United States
(12) Patent Application Publication
(10) Pub. No.: US 2026/0002057 A1
(43) Pub. Date: Jan. 1, 2026

(54) PHOTOCURABLE RESIN FOR PRESSURE-SENSITIVE, ANISOTOPICALLY-CONDUCTIVE ADHESIVES AND METHODS OF MAKING AND USING THE SAME

(71) Applicant: E Ink Corporation, Billerica, MA (US)

(72) Inventor: Michael Lis, North Andover, MA (US)

(21) Appl. No.: 19/256,969

(22) Filed: Jul. 1, 2025

Related U.S. Application Data
(60) Provisional application No. 63/666,506, filed on Jul. 1, 2024.

(51) Int. Cl. C09J 9/02; C08K 3/04; C08K 3/08; C08K 5/5397; C08K 7/00; C08K 9/02; C09J 4/06; C09J 7/38

(52) U.S. Cl. CPC C09J 9/02; C08K 3/04; C08K 3/08; C08K 5/5397; C08K 7/00; C08K 9/02; C09J 4/06; C09J 7/385; C08K 2003/0862; C09J 2301/302; C09J 2301/408; C09J 2433/00

(57) ABSTRACT

Pressure-sensitive, anisotopically-conductive adhesives comprising a radiation-cured resin having aligned conductive particles therein and methods of making and processing are disclosed herein. The pressure-sensitive, anisotopically-conductive adhesive wherein the pressure-sensitive, anisotropically-conductive adhesive has a higher electrical conductivity in a direction parallel to the aligned conductive particles than in a direction perpendicular to the aligned conductive particles, wherein the resin prior to curing comprises: from 25-70% by wt. of one or more acrylic or methacrylic oligomers mixtures, from 5-60% by wt. of a reactive diluent, from 0-25% by wt. of an adhesion promoter, and an effective amount of a photoinitiator to initiate the curing of the resin when exposed to radiation; and wherein the resin prior to curing is mixed with the conductive particles in an amount below a percolation threshold.

### CROSS-REFERENCE TO RELATED APPLICATION

This application claims benefit of priority to U.S. Patent Application Ser. No. 63/666,506, filed Jul. 1, 2024, the contents of which are incorporated herein by reference.

### BACKGROUND OF THE INVENTION

UV-cured pressure-sensitive adhesives (PSAs) are formulations with a liquid-state monomer containing a photoinitiator coated on a backing sheet and exposed to UV light. The cured material possesses the complex mechanical properties required of a PSA. The adhesive must be soft enough and sufficiently match surface energy to conform to the surface, but also possess sufficient “tack” to lend adhesive strength. Conductive, pressure-sensitive and hot-melt adhesives have been utilized in various displays, including electro-optic displays. Exemplary adhesives are described in US 2003/0011867, U.S. Pat. No. 6,831,769, US 2005/0007336, U.S. Pat. Nos. 7,110,163, 7,986,450, U.S. Pat. Nos. 9,964,831, 6,831,769, and 10,150,899. Generally, these adhesives use of an ionic charge carrier inside the adhesive to give conductive properties. The conductive properties of these materials are temperature-sensitive and rely on the diffusion of ions.

Another approach to create a conductive adhesive is to fill the adhesive with particles above the percolation threshold, as described in US 2003/0011867. Theoretically the resulting adhesive is less temperature-dependent, but the high in-plane conductivity leads to loss of resolution in the display through “blooming” artifacts. Yet another approach to eliminate the temperature dependence is to prepare an anisotropically conductive adhesive, where conductive particles are aligned into vertical pillars inside an insulating medium by either electric or magnetic fields. Exemplary adhesives are described in U.S. Pat. Nos. 7,843,626, 7,110,163, and 10,613,407.

Anisotropic adhesives have focused on cure-in-place UV adhesives, as solvent-borne PSAs would deform the pillars upon drying. These adhesives are significantly harder to process, as processing requires alignment and device fabrication to occur in the same step. Moreover, solvent-based adhesives such as those used for ion conduction are incompatible with the alignment process because of the drying process. Alignment can only occur when viscosity is sufficiently low, but adhesive must be dried on a substrate to have sufficient strength. Drying of an aligned film distorts and breaks the conductive pillars.

Accordingly, there is a need for UV-curable resins and pressure-sensitive, anisotopically-conductive adhesives that overcome the challenges in the art.

### BRIEF SUMMARY OF THE INVENTION

Disclosed herein are pressure-sensitive, anisotopically-conductive adhesives, articles, methods and uses of the same.

One aspect of the invention provides a pressure-sensitive, anisotopically-conductive adhesive comprising a radiation-cured resin having aligned conductive particles therein, wherein the pressure-sensitive, anisotropically-conductive adhesive has a higher electrical conductivity in a direction parallel to the aligned conductive particles than in a direction perpendicular to the aligned conductive particles, wherein the resin prior to curing comprises: from 25-70% by wt. of one or more acrylic or methacrylic oligomers mixtures, from 5-70% by wt. of a reactive diluent, from 0-25% by wt. of an adhesion promoter; and an effective amount of a photoinitiator to initiate the curing of the resin when exposed to radiation, and wherein the resin prior to curing is mixed with the conductive particles in an amount below a percolation threshold.

In some embodiments, the pressure-sensitive, anisotopically-conductive adhesive of claim 1, wherein the resin prior to curing is mixed with 0.1-20% conductive particles by weight. In some embodiments, the conductive particles are selected from carbon black, carbon nanotubes, graphite flakes, metal spheres, metal wires, metal flakes, metal-coated glass spheres, metal-coated glass flakes, graphite microbeads, and any combination thereof. In some embodiments, the metal spheres, metal wires, metal flakes, metal-coated glass spheres, or metal-coated glass flakes comprise one or more metals selected from silver, gold, nickel, copper, combinations thereof, or alloys thereof.

In some embodiments, the resin prior to curing comprises from 1-25% by wt. of the adhesion promoter. In some embodiments, the adhesion promoter comprises one or more acidic monomers or oligomers and/or one or more acid esters. In some embodiments, the adhesion promoter comprises one or more acidic monomers or oligomers selected from acidic acrylates, acrylic acid, 2-carboxyethyl acrylate, and combinations thereof. In some embodiments, the adhesion promoter comprises one or more components selected from 2-hydroxyethyl methacrylate phosphate in 2-(2-ethoxyethoxy)ethyl acrylate, 2-hydroxyethyl methacrylate phosphate in ethoxylated trimethylolpropane triacrylate, high entropy alloy phosphate in ethoxylated trimethylolpropane triacrylate, or an acid based adhesion promoter.

In some embodiments, the one or more acrylic or methacrylic oligomers mixtures comprises, aliphatic urethane acrylate, difunctional aliphatic urethane acrylate oligomer diluted with ethoxylated trimethylolpropane triacrylate, aliphatic urethane acrylate blended with isobornyl acrylate, tin-free aliphatic urethane acrylate, tin-free difunctional aliphatic urethane acrylate, low viscosity aliphatic urethane acrylate, tackifying acrylate, and combinations thereof.

In some embodiments, the reactive diluent comprises 2(2-ethoxyethoxy)ethyl acrylate, 2-phenoxylethyl acrylate, 2-ethylhexyl acrylate, isodecyl acrylate, isooctyl acrylate, tridecyl acrylate, caprolactone acrylate, isobornyl acrylate, alkoxylated tetrahydrofurfuryl acrylates, alkoylated phenol acrylates, benzyl (meth)acrylate, phenoxylethyl (meth)acrylate, phenol (EO) n acrylate, methoxy PEG methacrylate, nonyl phenol (EO), acrylate, nonyl phenol (PO)₂ acrylate, and cyclic trimethylolpropane formal acrylate (CTFA) and combinations thereof, wherein n is selected from 2, 4, 6, and 8.

In some embodiments, the photoinitiator is TPO/TPO-L.

Another aspect of the invention provides a method for preparing a pressure-sensitive, anisotopically-conductive adhesive, the method comprising: mixing the resin with the conductive particles in an amount below a percolation threshold; aligning the conductive particles within the resin; and exposing the mixture of resign and aligned conductive particles within the resin to radiation to cure the resin.

In yet another aspect, the invention provides the article for applying the pressure-sensitive, anisotopically-conductive adhesive, the article comprising the pressure-sensitive, anisotopically-conductive adhesive disposed on a first sheet of release film, wherein the article optionally comprises a second sheet of release film disposed on the pressure-sensitive, anisotopically-conductive adhesive opposite the first sheet of release film.

Another aspect of the invention provides a method for preparing the article method comprising mixing the resin with the conductive particles in an amount below a percolation threshold, disposing the mixture comprising the resin and conductive particles onto the first sheet of transfer film, aligning the conductive particles within the resin on the first transfer film, and exposing the mixture of resign and aligned conductive particles within the resin to radiation to cure the resin on the first sheet of transfer film.

An aspect of the present disclosure provides a display assembly comprising the pressure-sensitive, anisotopically-conductive adhesive disposed on a first substrate, wherein the display assembly optionally comprises a second substrate disposed on the pressure-sensitive, anisotopically-conductive adhesive opposite the first substrate.

In a further aspect, the invention provides a method for preparing a display assembly comprising disposing the pressure-sensitive, anisotopically-conductive adhesive on the first substrate.

In another aspect, the present disclosure provides a display assembly comprising the pressure-sensitive, anisotopically-conductive adhesive disposed on a first substrate, wherein the display assembly optionally comprises a second substrate disposed on the pressure-sensitive, anisotopically-conductive adhesive opposite the first substrate.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows a representative cross-section of a four-particle electro-optic display wherein the electro-optic medium is encapsulated in microcapsules.

FIG. 2 shows an exemplary schematic cross-section through a front plane laminate showing the manner in which the release sheet is peeled from the laminate prior to incorporation of the laminate into a display.

FIG. 3A illustrates an exemplary equivalent circuit of a single pixel of an electro-optic display that uses an active matrix backplane with a storage capacitor.

FIG. 3B illustrates an exemplary equivalent circuit of a simplified electro-optic display of the invention, allowing driving in a row-column format.

FIG. 4 illustrates an exemplary electro-optic display that includes a display module. The electro-optic display also includes a processor, memory, one or more power supplies, and a controller. The electro-optic display may also include sensors to allow the electro-optic display to adjust operational parameters based upon the ambient environment, e.g., temperature and illumination.

FIG. 5 illustrates top and side views of a test cell including interdigitated electrodes that can be used to measure lateral impedance across the interdigitated electrodes. Impedance can be compared between different adhesive types, including resin alone, adhesive including unaligned conductive particles, and adhesive including aligned conductive particles.

FIG. 6 shows the impedance of formulation 89C conductive adhesive measured with the test cell of FIG. 5 when the conductive particles are unaligned. The impedance was measured both vertically (from test glass to PET/ITO) and planar (between interdigitated electrodes). Because the conductive particles are not aligned, the measured impedances are similar in both directions.

FIG. 7 shows the impedance of formulation 89C conductive adhesive measured with the test cell of FIG. 5 when the conductive particles are aligned vertically (i.e., normal to the plane of the test glass). The impedance was measured both vertically (from test glass to PET/ITO) and planar (between interdigitated electrodes). Because the conductive particles are aligned, the planar impedance (between interdigitated electrodes) is much higher than the vertical impedance. Additionally, the vertical impedance is smaller in the vertical direction for the aligned adhesive than the unaligned adhesive (compare FIG. 6 and FIG. 7).

FIG. 8 shows the impedance of formulation 89C aligned at 25° C. and −10° C.

FIG. 9 shows a blooming study of a black and white encapsulated electrophoretic medium on an active matrix backplane done at 65° C. for an isotropic alignment control (top) compared to formulation 89C (bottom) with vertically-aligned conductive particles. Using the active matrix backplane it was possible to conduct the tests at 1 pixel×1 pixel resolution (left), 2 pixel×2 pixel resolution (middle) and 10 pixel×10 pixel resolution (right). Notably, the aligned adhesive achieved much cleaner edges between black and white squares.

### DETAILED DESCRIPTION OF THE INVENTION

The disclosure is directed to an anisotropically-conductive, pressure sensitive adhesive for use in the manufacture of an electro-optic display. The present disclosure is directed to compositions, articles, display assemblies, and corresponding methods. The anisotropically-conductive, pressure sensitive adhesive has a higher conductivity in a direction perpendicular to an adhesive layer than in the plane of the adhesive layer to prevent a loss of resolution due to in-plane conductivity (e.g., blooming artifacts).

The presently disclosed technology overcomes several issues in the prior art. Previous attempts to prepare anisotropically-conductive adhesives were focused on cure-in-place adhesive systems. Cure-in-place adhesives required complicated processing as alignment and device fabrication had to occur together. Moreover, solvent-based adhesives are incompatible with alignment. Drying of an anisotropically aligned film distorts and breaks conductive pillars. Pressure-sensitive adhesives, such as those described herein, overcome the challenges in the art. Importantly, the pressure-sensitive adhesive can be cured on a release film and transferred between substrates, thereby facilitating manufacture of devices such as electro-optic and electrophoretic displays.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electro-optic displays, microcell electro-optic displays and encapsulated liquid crystal displays.

### Electro-Optic Display

An electro-optic display may comprise a layer of a solid electro-optic medium and at least two other layers disposed on opposed sides of the electro-optic medium, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous (light-transmissive) electrode and the other electrode layer is patterned into a matrix of pixel electrodes, each of which defines one pixel of the display.

The term “light transmissive” is used herein to mean that the layer thus designated transmits sufficient light to enable an observer, looking through that layer, to observe the change in display states of the electro-optic medium, which will normally be viewed through the light transmissive electrode layer and adjacent substrate (if present); in cases where the electro-optic medium displays a change in reflectivity at non-visible wavelengths, the term “light-transmissive” should of course be interpreted to refer to transmission of the relevant non-visible wavelengths.

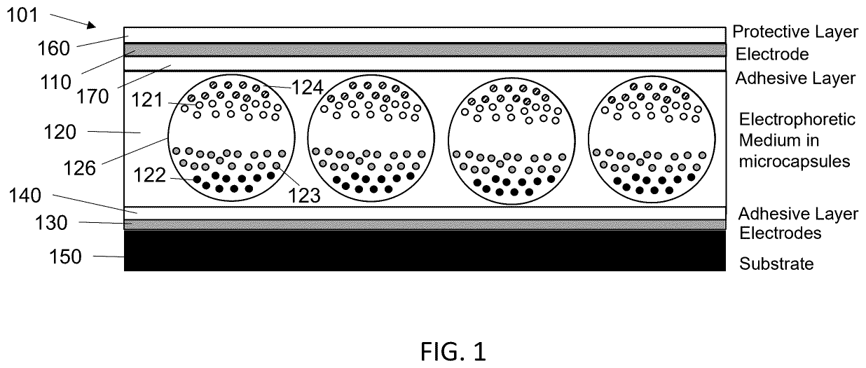

FIG. 1 illustrates an example of an electro-optic display comprising microcapsules. An electro-optic display (101) typically includes a top transparent electrode 110, an electro-optic medium 120, and a bottom electrode 130, which is often a pixel electrode of an active matrix of pixels controlled with thin film transistors (TFT). However, the bottom electrode 130 can be a singular larger electrode, such as a graphite backplane, a film of PET/ITO, a metalized film, or a conductive paint. While the electro-optic medium is depicted in FIG. 1 as being encapsulated in microcapsules, the electro-optic medium can also be encapsulated in microcells, e.g., embossed microcells that are filled with the electro-optic medium and then sealed with a sealing layer.

The manufacture of a three-layer electro-optic display normally involves at least one lamination operation. For example, manufacturing of an electro-optic display may comprise coating an electro-optic medium comprising capsules in a binder on to a flexible substrate comprising indium-tin-oxide (ITO) or a similar conductive coating (which acts as one electrode of the final display) on a plastic film, drying the capsules/binder coating to form a coherent layer of the electro-optic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. In some embodiments, the backplane is flexible and is prepared by printing the pixel electrodes and conductors on a plastic film or other flexible substrate. The obvious lamination technique for mass production of displays by this process is roll lamination using a lamination adhesive. Similar manufacturing techniques can be used with other types of electro-optic displays. For example, a microcell electro-optic medium or a rotating bichromal member medium may be laminated to a backplane in substantially the same manner.

U.S. Pat. No. 6,982,178 describes a method of assembling a solid electro-optic display (including an encapsulated electrophoretic display) which is well adapted for mass production. This patent describes a so-called “front plane laminate” (“FPL”) which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially. Such films are available in bulk from various producers, such as Saint Gobain.

Assembly of an electro-optic display using an FPL may be affected by removing the release sheet from the FPL and contacting the adhesive layer with a backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes. In some embodiments, the backplane is microfabricated to include an active matrix of transistors.

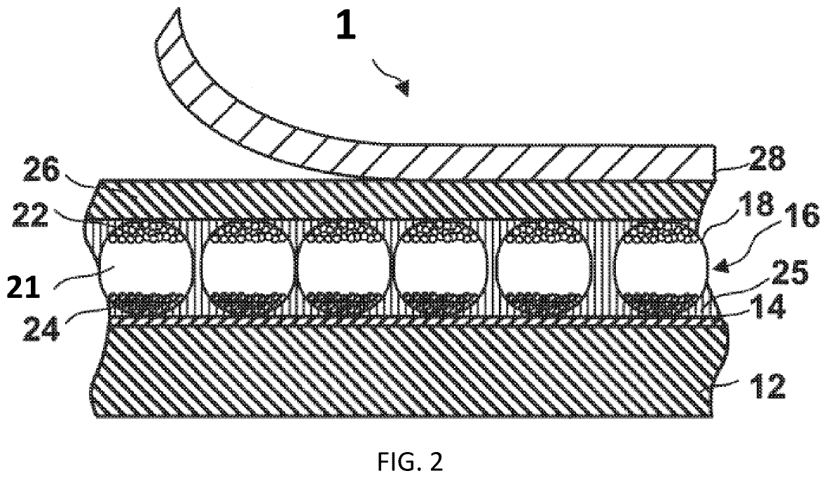

FIG. 2 shows an exemplary cross-section view of a front plane laminate with the release sheet being peeled from the laminate prior to incorporation of the laminate into a display. As shown in FIG. 2, the laminate (generally designated 1) comprises a light transmissive substrate 12, which has the form of a transparent plastic film. Although not shown in FIG. 2, the substrate 12, the lower surface of which (as illustrated in FIG. 2) forms the viewing surface of the final display, may have one or more additional layers, for example a protective layer to absorb ultra-violet radiation, barrier layers to prevent ingress of oxygen or moisture into the final display, and anti-reflection coatings to improve the optical properties of the final display. The substrate 12 carries a thin light-transmissive electrically-conductive layer 14, preferably of ITO, which acts as the front electrode in the final display.

A layer (generally designated 16) of an electro-optic medium is deposited upon, and in electrical contact with, the conductive layer 14. The electro-optic medium comprises a plurality of microcapsules, each of which comprises a capsule wall 18 containing a hydrocarbon-based liquid 21 in which are suspended two kinds of charged pigment particles. However, electro-optic media disclosed herein may also comprise three, four, or more than four sets of different kinds of charged pigment particles in different embodiments of the present invention. The laminate 1 further comprises a layer 26 of lamination adhesive coated over the electro-optic medium layer 16 and a release layer 28 covering the adhesive layer 26. The release layer may be provided with any appropriate release coating, for example a silicone coating. As illustrated at the left side of FIG. 2, the release layer 28 is peeled from the adhesive layer 26 before the laminate is laminated, by means of the adhesive layer 26, to a backplane to form the final display.

Alternatively, “double release sheets” such as described in U.S. Pat. No. 7,561,324 may be used. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate (FPL) already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

In yet another alternative, “inverted front plane laminate” such as described in U.S. Pat. No. 7,839,564 may be used. This inverted front plane laminate comprises, in order, at least one of a light-transmissive protective layer and a light-transmissive electrically-conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive is present between the electro-optic layer and a backplane. Such electro-optic displays can combine good resolution with good low temperature performance.

The release sheet used in the front plane laminate of the present invention can be of any known type, provided of course that it does not contain materials which might adversely affect the properties of the electro-optic medium, and numerous suitable types of release sheet will be known to those skilled in the art. Typical release sheets comprise a substrate such as paper or a plastic film coated with a low surface energy material, for example a silicone.

### Adhesive Layer

The adhesive layer plays an important role in controlling the overall voltage drop across the electro-optic medium. The electro-optic medium is a critical factor in the performance of the medium as the voltage drop across the electrooptic medium is equal to the voltage drop across the electrodes, minus the voltage drop across the lamination adhesive. If the resistivity of the adhesive layer is too high, a substantial voltage drop will occur within the adhesive layer, requiring higher voltages between the electrodes to produce a working voltage drop at the electro-optic medium. This undeniably increases the voltage across the electrodes, however, because it increases power consumption, it may require the use of more complex and expensive control circuitry to produce and switch the increased voltages. On the other hand, if the resistivity of the adhesive layer is too low, there will be undesirable communication between adjacent electrodes (i.e., active matrix electrodes) or the device may short out. Also, because the volume resistivity of most materials decreases rapidly with increasing temperature, if the volume resistivity of the adhesive is too low, the performance of the display will vary greatly with temperatures substantially above room temperature.

For these reasons, there is an optimum range of lamination adhesive resistivity values for use with most electro-optic media, this range varying with the resistivity of the electro-optic medium. The volume resistivities of encapsulated electrophoretic media are typically around 1010 Ohm cm, and the resistivities of other electro-optic media are usually of the same order of magnitude. Accordingly, the volume resistivity of the lamination adhesive should normally be around 108 to 1012 Ohm cm, or about 109 to 1011 Ohm cm at the desired operating temperature. Although some displays are intended to operate around room temperature, typically around 20° C., in other instances the electro-optic displays are intended to perform at colder or warmer temperatures, including for outdoor use. Accordingly, the volume resistivity should be suitable for operating at temperatures as low as −20° C. or −10° C. or as high as 60° C. or 70° C., including any temperature therebetween. Preferably, the lamination adhesive will also have a variation of volume resistivity with temperature that is similar to the electro-optic medium itself.

In addition to the electrical properties, the lamination adhesive must fulfill several mechanical and rheological criteria, including strength of adhesive, flexibility, ability to withstand and flow at lamination temperatures, etc. The number of commercially-available adhesives which can meet all the relevant electrical and mechanical criteria is small, and in practice, the most suitable lamination adhesives are certain polyurethanes, such as those described in U.S. Pat. No. 7,342,068.

There may be more than one adhesive layer in a given electro-optic display, however only one layer is more common. The entire display stack is typically disposed on a substrate, which may be rigid or flexible. The display typically also includes a protective layer, which may simply protect the top electrode from damage, or it may envelop the entire display to prevent ingress of water, etc. electro-optic displays may also include sealing layers as needed. The formulations of the invention, i.e., as described herein, overcome the shortcomings of the prior art by providing adhesive and/or planarizing layers with improved conductivity, adhesion, and optical characteristics. The formulations are well-suited for use with a variety of electro-optic media.

The present disclosure presents a pressure-sensitive, anisotopically-conductive adhesive comprising a radiation-cured resin having aligned conductive particles therein. The pressure-sensitive, anisotropically-conductive adhesive has a higher electrical conductivity in a direction parallel to the aligned conductive particles than in a direction perpendicular to the aligned conductive particles. The resin prior to curing comprises from 25-70% by weight of one or more acrylic or methacrylic oligomers mixtures, from 5-70% by weight of a reactive diluent, from 0-25% by weight of an adhesion promoter, and an effective amount of a photoinitiator to initiate the curing of the resin when exposed to radiation. The resin prior to curing is mixed with the conductive particles in an amount below a percolation threshold. In some embodiments, the resin prior to curing is mixed with 0.1-20% conductive particles by weight.

Standard, solvent-based adhesives like those used for ion conduction are generally incompatible with the alignment process because of the drying process. Alignment can only occur when viscosity is sufficiently low, but adhesive must be dried on a substrate to have sufficient peel strength. Drying of an aligned film can distort and break the conductive pillars. The disclosed invention allows for the fabrication of anisotropic adhesives, which side-step the normal tradeoff between z conductivity for ink switching with the x-y plane conductivity that causes “blooming”, or a loss in pixel resolution.

The pressure-sensitive, anisotopically-conductive adhesive can be used for a variety of applications where a low-solvent, specific conductivity coating is beneficial, such as in the construction of an electro-optic display. The polymer composition may also include metal oxide particles, e.g., metal oxide nanoparticles. The metal oxide nanoparticles can be selected to alter the index of refraction of the composition so that the overall index of refraction of a layered active material, e.g., a front plane laminate (FPL), matches the index of refraction of the substrate upon which the FPL is placed. For example, the index of refraction of the composition can be engineered to be between 1.0 and 2.0 for visible light. The oligomer mixtures may additionally include photoinitiators to facilitate UV curing, and/or cross-linkers to improve strength.

The pressure-sensitive, anisotopically-conductive adhesive of the invention can be used to planarize (make smooth) surfaces with undesired surface morphology, while leaving the surface prepared for bonding or laminating with another structure. For example, the compositions can be spread over an irregular surface and cured to create an adhesive layer that is thin, smooth, and with substantially no voids left between the irregular surface and the composition. While any number of irregular surfaces can be smoothed with the described formulations, the formulations are well suited for the fabrication of microelectronics where there is a need for careful control of the thickness and resistivity of intervening adhesive layers. As described herein, the formulations can be distributed over a surface with spraying, spreading, laminating, pouring, or spin coating. Once applied, the composition can be cured, e.g., by applying heat or by activating with light, e.g., UV light.

The amount of one or more acrylic or methacrylic oligomers mixtures in the resin may vary. In some embodiments, the amount of oligomers mixture present in the resin is at least 25%, at least 30%, at least 35%, at least 40%, at least 45%, at least 50%, at least 55%, at least 60%, at least 65%, or at least 70%. In some embodiments, the amount of oligomers mixture present in the resin may range from about 25% to about 70%, 35% to about 60%, or from about 45% to about 55%. The one or more acrylic or methacrylic oligomers mixtures may comprise aliphatic urethane acrylate, difunctional aliphatic urethane acrylate oligomer diluted with ethoxylated trimethylolpropane triacrylate, aliphatic urethane acrylate blended with isobornyl acrylate, tin-free aliphatic urethane acrylate oligomer, difunctional aliphatic urethane acrylate, low viscosity aliphatic urethane acrylate, tackifying acrylate oligomer, and combinations thereof. A commercially available example of aliphatic urethane acrylate include SARTOMER® CN9018. A commercially available example of difunctional aliphatic urethane acrylate oligomer diluted with ethoxylated trimethylolpropane triacrylate include SARTOMER® CN966H90. A commercially available example of aliphatic urethane acrylate blended with isobornyl acrylate include SARTOMER® CN966J75. A commercially available example of tin-free aliphatic urethane acrylate oligomer include SARTOMER® CN9071. A commercially available example of difunctional aliphatic urethane acrylate include SARTOMER® CN9073. A commercially available example of low viscosity aliphatic urethane acrylate include SARTOMER® CN9074. Examples of tackifying acrylate oligomer include SARTOMER® CN3007 and SARTOMER® CN3008. In some instances, the one or more acrylic or methacrylic comprise include one or more of SARTOMER® CN3007, SARTOMER® CN3008, SARTOMER® CN9018, SARTOMER® CN966H90, SARTOMER® CN966J75, SARTOMER® CN9071, SARTOMER® CN9073, or SARTOMER® CN9074.

The amount of reactive dilutant in the resin may vary. In some embodiments, the amount of reactive dilutant present in the resin is at least 5%, at least 10%, at least 15%, at least 20%, at least 25%, at least 30%, at least 35%, at least 40%, at least 45%, at least 50%, at least 55%, at least 60%, at least 65%, or at least 70%. In some embodiments, the amount of reactive dilutent present in the resin may range from about 5% to about 70%, 10% to about 65%, 15% to about 60%, 25% to about 55%, 35% to about 50%, or from about 45% to about 55%. The reactive diluent may comprise 2(2-ethoxyethoxy)ethyl acrylate, 2-phenoxylethyl acrylate, 2-ethylhexyl acrylate, isodecyl acrylate, isooctyl acrylate, tridecyl acrylate, caprolactone acrylate, isobornyl acrylate, alkoxylated tetrahydrofurfuryl acrylates, alkoylated phenol acrylates, benzyl (meth)acrylate, phenoxylethyl (meth)acrylate, phenol (EO), acrylate, methoxy PEG methacrylate, nonyl phenol (EO)ₙ acrylate, nonyl phenol (PO)₂ acrylate, and cyclic trimethylolpropane formal acrylate (CTFA) and combinations thereof, wherein n is selected from 2, 4, 6, and 8.

The amount of adhesion promoter present in the resin may vary. In some embodiments, the amount of adhesion promoter present in the resin is at least 1%, at least 2%, at least 3%, at least 5%, at least 10%, at least 15%, at least 20%, or at least 25%. In some embodiments, the amount of adhesion promoter present in the resin may range from about 1% to about 25%, 5% to about 20%, or from about 10% to about 15%. In some embodiments, the adhesion promoter comprises one or more acidic monomers or oligomers and/or one or more acid esters. In some embodiments, the resin prior to curing comprises from 1-25% by wt. of the adhesion promoter comprising one or more acidic monomers or oligomers and/or one or more acid esters. In some embodiments, the adhesion promoter comprises one or more acidic monomers or oligomers selected from acidic acrylates, acrylic acid, 2-carboxyethyl acrylate, and combinations thereof. A commercially available example of acidic acrylates include SARTOMER® CD9055. In some instances, adhesion promoter comprises SARTOMER® CD9055.

In some embodiments, the adhesion promoter comprises one or more acidic monomers or oligomers selected from 2-hydroxyethyl methacrylate phosphate in 2-(2-ethoxyethoxy)ethyl acrylate, 2-hydroxyethyl methacrylate phosphate in ethoxylated trimethylolpropane triacrylate, high entropy alloy (HEA)phosphate in ethoxylated trimethylolpropane triacrylate, or an acid-based adhesion promoter or combinations thereof. A commercially available example of 2-hydroxyethyl methacrylate phosphate in 2-(2-ethoxyethoxy)ethyl acrylate includes SARTOMER® SR9050. A commercially available example of 2-hydroxyethyl methacrylate phosphate in ethoxylated trimethylolpropane triacrylate includes SARTOMER® SR9051. A commercially available examples of high entropy alloy (HEA)phosphate in ethoxylated trimethylolpropane triacrylate includes SARTOMER® SR9053. A commercially available example of an acid-based adhesion promoter includes SARTOMER® SR9054. In some instances, the adhesion promoter comprises one or more acidic monomers or oligomers comprises one or more of SARTOMER® Sartomer SR9050, SARTOMER® SR9051, SARTOMER® SR9053, or SARTOMER® SR9054.

The amount of one or more acrylic or methacrylic oligomers mixtures in the resin may vary. In some embodiments, the amount of oligomers mixture present in the resin is at least 1%, at least 2%, at least 3%, at least 4%, or at least 5%. In some embodiments, the amount of oligomers mixture present in the resin may range from about 1% to about 5%, 2% to about 4%, or from about 3% to about 5%.

The photoinitiator may be selected from a wide range of Type I or Type II photoinitators. In some embodiments, the photoinitiator may be selected from polyesteracrylates, epoxyacrylates, benzophenones, and phosphine oxides. In some embodiments, the photoinitator is a phosphine oxide. In some embodiments, the photoinitiator is TPO/TPO-L. Typical amounts of photoinititor around from about 1% to 10%, 2% to 8%, or 3% to 7% by wt. of the photoinitiator. Alternative photoinitiators may include Omnirad 369, Omnipol TP (oligomeric TPO), DETX, Keocoumarin, Photomer 4697, or Michler's Ketone.

The conductive particles may be selected from carbon black, carbon nanotubes, graphite flakes, metal spheres, metal wires, metal flakes, metal-coated glass spheres, metal-coated glass flakes, graphite microbeads, and any combination thereof. In some embodiments, the metal spheres, metal wires, metal flakes, metal-coated glass spheres, or metal-coated glass flakes comprise one or more metals selected from silver, gold, nickel, copper, combinations thereof, or alloys thereof. For example, conductive particles may be silver-coated nickel flakes having an average size between 5-20 μm, graphite flakes having an average size between 10-30 μm, or carbon black. In some embodiments, the conductive particles are aligned by applying an alternating electric field.

In some embodiments, the conductive particles are selected from carbon black, carbon nanotubes, graphite flakes, metal spheres, metal wires, metal flakes, metal-coated glass spheres, metal-coated glass flakes, and any combination thereof; the one or more acrylic or methacrylic oligomers mixtures comprises aliphatic urethane acrylate, difunctional aliphatic urethane acrylate oligomer diluted with ethoxylated trimethylolpropane triacrylate, aliphatic urethane acrylate blended with isobornyl acrylate, tin-free aliphatic urethane acrylate oligomer, tin-free difunctional aliphatic urethane acrylate, low viscosity aliphatic urethane acrylate, tackifying acrylate oligomer, and combinations thereof; and, the reactive diluent comprises 2(2-ethoxyethoxy)ethyl acrylate, 2-phenoxylethyl acrylate, 2-ethylhexyl acrylate, isodecyl acrylate, isooctyl acrylate, tridecyl acrylate, caprolactone acrylate, isobornyl acrylate, alkoxylated tetrahydrofurfuryl acrylates, alkoylated phenol acrylates, and combinations thereof.

In some embodiments, one or more acrylic or methacrylic oligomers mixtures comprise aliphatic urethane acrylate and wherein the reactive diluent comprises caprolactone acrylate and/or isobornyl acrylate. Commercially available examples of caprolactone acrylate include SARTOMER® SR495B. In further embodiments, the resin comprises between 25-35% by wt. of the one or more acrylic or methacrylic oligomers mixtures; from 60-70% by wt. of the reactive diluent; and between 3-7% by wt. of the photoinitiator. In some embodiments, the resin prior to curing is mixed with 0.1-20% conductive particles by weight. In some embodiments, the conductive particles comprise 7-9 wt. % of silver-coated nickel flakes having an average size between 5-20 μm.

In some embodiments, one or more acrylic or methacrylic oligomers mixtures comprise aliphatic urethane acrylate and wherein the reactive diluent comprises 2(2-ethoxyethoxy)ethyl acrylate. Commercially available examples of 2 (2-ethoxyethoxy)ethyl acrylate include SARTOMER® SR256. In further embodiments, the resin comprises between 35-45% by wt. of the one or more acrylic or methacrylic oligomers mixtures; from 55-65% by wt. of the reactive diluent; and between 3-7% by wt. of the photoinitiator. In some embodiments, the resin prior to curing is mixed with 0.1-20% conductive particles by weight. In some embodiments, the conductive particles comprise 7-9 wt. % of silver-coated nickel flakes having an average size between 5-20 μm.

In some embodiments, one or more acrylic or methacrylic oligomers mixtures comprises tin-free difunctional aliphatic urethane acrylate; wherein the reactive diluent comprises alkoxylated phenol acrylate; and wherein the resin comprises acidic acrylates. Commercially available examples of alkoxylated phenol acrylate include SARTOMER® SR9087. In further embodiments, the resin comprises between 35-45% by wt. of the one or more acrylic or methacrylic oligomers mixtures; from 15-25% of the adhesion promoter; and from 55-65% by wt. of the reactive diluent; and between 3-7% by wt. of the photoinitiator. In some embodiments, the resin prior to curing is mixed with 0.1-20 by wt. % of conductive particles. In some embodiments, the conductive particles comprise 7-9 wt. % of silver-coated nickel flakes having an average size between 5-20 μm, or comprise 7-9 wt. % of graphite flakes having an average size between 10-30 μm, or 0.1-2 wt. % of carbon black.

One aspect of the disclosure presents a method for preparing a pressure-sensitive, anisotopically-conductive adhesive. The method comprises mixing the resin with the conductive particles in an amount below a percolation threshold, aligning the conductive particles within the resin, and exposing the mixture of resign and aligned conductive particles within the resin to radiation to cure the resin. In some embodiments, the radiation is ultraviolet radiation. In some embodiments, the conductive particles are aligned by applying an alternating electric field the mixture comprising the resin and conductive particles. In some embodiments, the field may have a frequency between 100 Hz and 1 MHz. In some embodiments, the electric field strength applied is between 0.4 and 10 MV/m. In some embodiments, the radiation is ultraviolet radiation.

Another aspect of the disclosure presents an article for applying the pressure-sensitive, anisotopically-conductive adhesive. The article comprises the pressure-sensitive, anisotopically-conductive adhesive disposed on a first sheet of release film, wherein the article optionally comprises a second sheet of release film disposed on the pressure-sensitive, anisotopically-conductive adhesive opposite the first sheet of release film. In some embodiments, the pressure-sensitive, anisotopically-conductive adhesive has a thickness between 1-500 micron. In some embodiments, the pressure-sensitive, anisotopically-conductive adhesive has a thickness between 1-20 micron.

Another aspect of the disclosure presents, a method for preparing the article. The method comprises mixing the resin with the conductive particles in an amount below a percolation threshold, disposing the mixture comprising the resin and conductive particles onto the first sheet of transfer film, aligning the conductive particles within the resin on the first transfer film, and exposing the mixture of resign and aligned conductive particles within the resin to radiation to cure the resin on the first sheet of transfer film. In some embodiments, the mixture comprising the resin and conductive particles is disposed onto the first sheet of transfer film by a linear coater or calendaring between two rollers. In some embodiments, the mixture comprising the resin and conductive particles has a thickness between 1-500 micron. In some embodiments, wherein the mixture comprising the resin and conductive particles has a thickness between 1-20 micron.

In some embodiments, the method further comprises disposing the second sheet of transfer film on the mixture comprising the resin and conductive particles. In some embodiments, the method further comprises pressing the first sheet of transfer film and the second sheet together to prepare the mixture comprising the resin and conductive particles having a thickness between 1-500 micron. In some embodiments, the method further comprises pressing the first sheet of transfer film and the second sheet together to prepare the mixture comprising the resin and conductive particles having a thickness between 1-20 micron.

Another aspect of the disclosure presents, a display assembly comprising the pressure-sensitive, anisotopically-conductive adhesive disposed on a first substrate, wherein the display assembly optionally comprises a second substrate disposed on the pressure-sensitive, anisotopically-conductive adhesive opposite the first substrate. In some embodiments, the pressure-sensitive, anisotopically-conductive adhesive has a thickness between 1-500 micron. In some embodiments, the pressure-sensitive, anisotopically-conductive adhesive has a thickness between 1-20 micron.

In some embodiments, the display assembly is an electro-optic display assembly. In some embodiments, the display assembly comprises a backplane assembly comprising the first substrate and a matrix of pixel electrodes defining individual pixels of a display. In some embodiments, the display assembly comprises a frontplane assembly comprising the first substrate and a continuous electrode configured to extend across multiple pixels of a display. In some embodiments, the display assembly comprises a backplane assembly comprising the first substrate and a matrix of pixel electrodes defining individual pixels of a display and a frontplane assembly comprising the second substrate and a continuous electrode configured to extend across multiple pixels of a display.

Another aspect of the invention discloses a method for preparing the display assembly. The method comprises disposing the pressure-sensitive, anisotopically-conductive adhesive on the first substrate. In some embodiments, the pressure-sensitive, anisotopically-conductive adhesive is disposed on the first substrate by contacting the first substrate with the pressure-sensitive, anisotopically-conductive adhesive disposed on a first sheet of release film. In some embodiments, wherein the display assembly is an electro-optic display assembly. In some embodiments, the display assembly comprises a backplane assembly comprising the first substrate and a matrix of pixel electrodes defining individual pixels of a display.

In some embodiments, the pressure-sensitive, anisotopically-conductive adhesive is disposed on the first substrate by contacting the first substrate with the pressure-sensitive, anisotopically-conductive adhesive disposed on a sheet of release film. In some embodiments, the display assembly comprises a frontplane assembly comprising the first substrate and a continuous electrode configured to extend across multiple pixels of the display. In some embodiments, the pressure-sensitive, anisotopically-conductive adhesive has a thickness between 1-20 microns. In some embodiments, the pressure-sensitive, anisotopically-conductive adhesive is disposed on the first substrate by contacting the first substrate with the pressure-sensitive, anisotopically-conductive adhesive disposed on a sheet of release film. In some embodiments, the display assembly comprises a backplane assembly comprising the first substrate and a matrix of pixel electrodes defining individual pixels of a display and a frontplane assembly comprising the second substrate and a continuous electrode configured to extend across multiple pixels of the display. In some embodiments, pressure-sensitive, anisotopically-conductive adhesive has a thickness between 1-20 microns. In some embodiments, the pressure-sensitive, anisotopically-conductive adhesive is disposed on the first substrate and the second substrate by contacting the first substrate or the second substrate with the pressure-sensitive, anisotopically-conductive adhesive disposed on a sheet of release film; releasing the sheet of release film and contacting the other of the first substrate or the second substrate with the pressure-sensitive, anisotopically-conductive adhesive.

### Driving the Device

For the most part, electro-optic media, such as described above, are designed to be driven with low voltage square waves, such as produced by a driver circuit from a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electro-optic media are driven directly via an isolated electrode (e.g., segmented electrode) the driving pulses are delivered as square waves, having an amplitude and a time width. See, for example, U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

Electro-optic displays typically have a backplane provided with a plurality of pixel electrodes each of which defines one pixel of the display. Each pixel electrode is typically disposed in a rectangular array of pixel electrodes and each pixel electrode is controlled with a thin-film transistor (TFT), and the TFTs are updated in a row-by-row fashion. Conventionally, a single common electrode extends over a large number of pixels, and normally the whole display is provided on the opposed side of the electro-optic medium. The single common electrode is coupled to the backplane via an isolated electrical connection, a.k.a., a “top plane connection.” The individual pixel electrodes may be driven directly (i.e., a separate conductor may be provided to each pixel electrode) or the pixel electrodes may be driven in an active matrix manner which will be familiar to those skilled in backplane technology. Since adjacent pixel electrodes will often be at different voltages, they must be separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media the medium overlying the gap does switch because of a phenomenon known as “blooming”.

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, for example a desired white pixel may include various shades of gray along the edges, a.k.a., “edge ghosting”. Furthermore, depending upon the type of display, i.e., black/white, color, black/white with color filter, the results of the edge ghosting can range from annoying to debilitating. In some cases, asymmetric blooming may contribute to edge ghosting. The severity of ghosting may increase with increasing temperature. Displays that have a limited amount of blooming at room-temperature (about 20° C.) may have more severe blooming at temperatures above 30° C., 40° C., 50° C., or 60° C. Severe blooming at such temperatures may render the display unsuitable for use at those temperatures.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays. While the bistable nature of electrophoretic displays allows for massive power savings over traditional “always on” displays such as LCD and LED, the bistability can lead to image retention between updates, e.g., “ghosts” or “image sticking”.

The term impulse, when used to refer to driving an electro-optic display, is used herein to refer to the integral of the applied voltage with respect to time during the period in which the display is driven. The term waveform, when used to refer to driving an electro-optic display is used to describe a series or pattern of voltages provided to an electro-optic medium over a given time period (seconds, frames, etc.) to produce a desired optical effect in the electro-optic medium.

Waveforms for driving four-particle electro-optic media have been described previously. Waveforms for driving color electro-optic displays having four particles are described in U.S. Pat. Nos. 9,921,451, 9,812,073, and 11,640,803, all of which are incorporated by reference herein. Most commercial electro-optic displays use amorphous silicon based thin-film transistors (TFTs) in the construction of active matrix backplanes (260) because of the wider availability of fabrication facilities and the costs of the various starting materials. Amorphous silicon thin-film transistors may become unstable when supplied gate voltages that would allow switching of voltages higher than about +/−15V, e.g., +/−24V. Accordingly, as described in previous patents/applications on such systems, improved performance is achieved by additionally changing the bias of the top light-transmissive electrode with respect to the bias on the backplane pixel electrodes, a technique known as top-plane switching. Thus, if a voltage of +30V (relative to the backplane) is needed, the top plane may be switched to −15V while the appropriate backplane pixel is switched to +15V. Methods for driving a four-particle electro-optic system with top-plane switching are described in greater detail in, for example, U.S. Pat. No. 9,921,451. In alternative embodiments, metal oxide semiconductors may be incorporated into thin film transistors for active matrix backplanes (260), including IGZO, i.e., as described in U.S. Pat. No. 11,776,496, which is incorporated by reference in its entirety.

In some embodiments, the electro-optic display may include only a first light-transmissive electrode, an electro-optic medium, and a second (rear) electrode, which may also be light-transmissive. However, to produce a high-resolution display each pixel must be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are connected to column drivers, which place upon the various column electrodes voltages selected to drive the pixels in the selected row to their desired optical states. The aforementioned voltages are relative to a common front electrode which is conventionally provided on the opposed side of the electro-optic medium from the non-linear array and extends across the whole display.

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. As used herein, “frames” are not limited to use with an active matrix backplane. However, the driving frames described herein can also be used to refer to a unit of time between updates of, e.g., a singular backplane. While it is possible to drive electro-optic media with an analog voltage signal, such as produced by a power supply and a potentiometer, the use of a digital controller discretizes the waveform into blocks that are typically on the order of 10 ms, however shorter or longer framewidths are possible.

In a conventional electro-optic display using an active matrix backplane, each pixel electrode has associated therewith a capacitor electrode (storage capacitor) such that the pixel electrode and the capacitor electrode form a capacitor; see, for example, International Patent Publication WO 01/07961. In some embodiments, N-type semiconductor (e.g., amorphous silicon) may be used to from the transistors and the “select” and “non-select” voltages applied to the gate electrodes can be positive and negative, respectively.

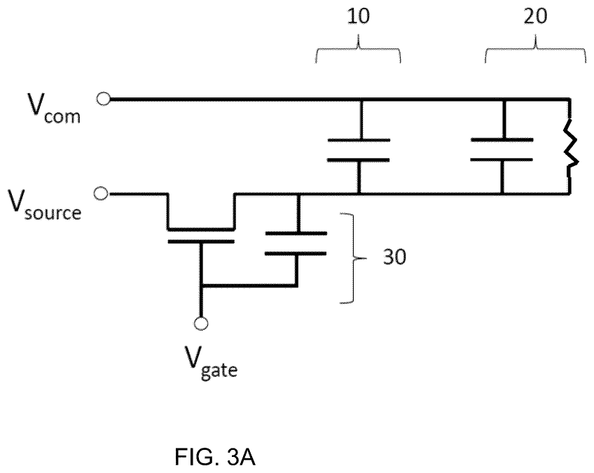

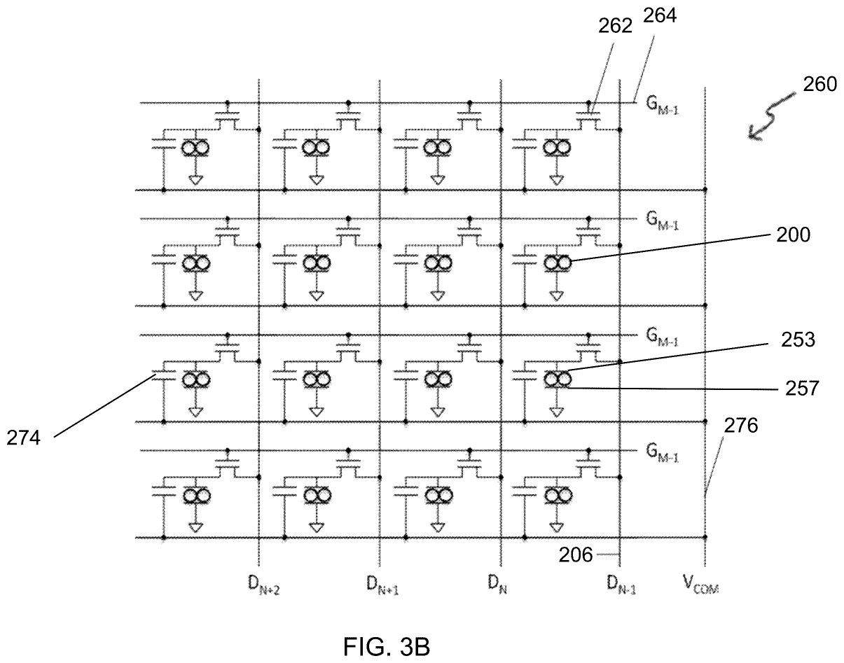

FIG. 3A depicts an exemplary equivalent circuit of a single pixel of an electro-optic display. As illustrated, the circuit includes a capacitor 10 formed between a pixel electrode and a capacitor electrode. The electro-optic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts.

In some embodiments, the TFT array forms an active matrix 260 for image driving, as shown in FIG. 3B. For example, each pixel electrode 253 (corresponding to 130 in FIG. 2) is coupled to a thin-film transistor 262 patterned into an array and connected to gate (row) driver lines 264 and source (column) driver lines 206, running at right angles to the gate drive lines 264. Also, typically, the common (top) light-transparent electrode 257 (corresponding to 110 in FIG. 2) has the form of a single continuous electrode while the other electrode or electrode layer is patterned into a matrix of pixel electrodes 253, each of which defines one pixel of the display. Between the pixel electrode 253 and the common electrode 257, an electro-optic medium 200 can be disposed. Any of the electro-optic media described above may be used, and while FIG. 3B depicts the electro-optic medium as contained in microcapsules, microcells, as shown in FIG. 2, are also suitable. A source driver (not shown) is connected to the source driver lines 206 and provides source voltage to all TFTs 262 in a column that are to be addressed. A gate driver (not shown) is connected to the gate driver lines 264 to provide a bias voltage that will open (or close) the gates of each TFT 262 along the row. Each pixel of the active matrix 260 also includes a storage capacitor 274 as discussed above with respect to FIG. 3A. The storage capacitors 274 may be coupled to a common potential (Vcom) line 276.

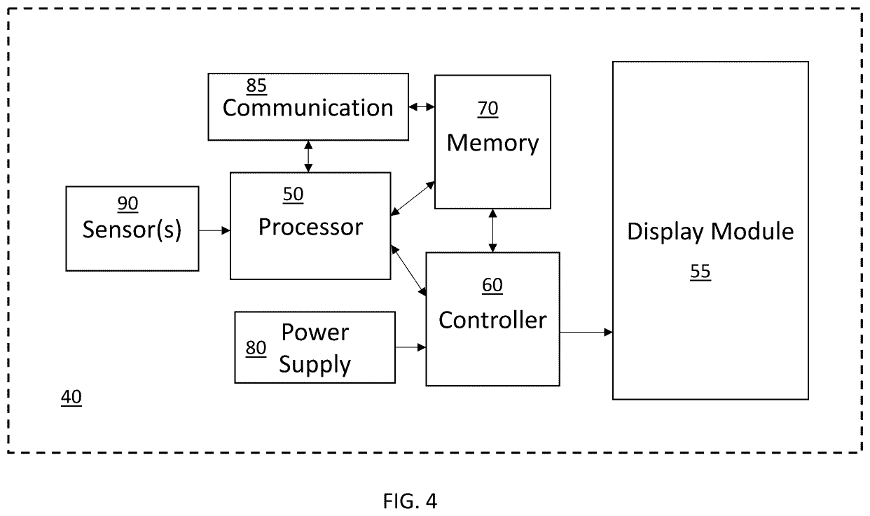

The active matrix 260 described with respect to FIG. 3B (i.e., including the electro-optic medium 200 and the common light-transparent electrode 257) is typically covered by a protective sheet (e.g., integrated barrier) and sealed to create a display module 55, as shown in FIG. 4. Such a display module 55 becomes the focus of an electro-optic display 40. The electro-optic display 40 will typically include a processor 50, which is configured to coordinate the many functions relating to displaying content on the display module 55, and to transform “standard” images, such as sRGB images to a color regime that best duplicates the image on the display module 55. In some embodiments, the processor 50 performs the methods of the invention by determining which pixel electrodes should be updated during a partial update. Especially when dithering is being used for color production, the processor 50 can determine which areas of the dithered color are most at risk from blooming due to nearby pixel electrode updates. In other embodiments, some or all of the steps of the invention may be completed by the controller 60. As controller 60 architecture advances, more of the image processing can be embedded into the controller 60 such that an advanced controller can be incorporated into the same package as the display module 55 and pre-programmed with the tools needed to identify pixel electrodes that are at risk of blooming during a partial update. Advanced controllers for electro-optic displays are available from ULTRACHIP and NEXTRONIX.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

The Examples demonstrate that UV-cured pressure-sensitive adhesives with reduced blooming compared to an isotropic control. The goal of these studies is to widen the operating temperature window of electro-optic devices. The Examples include three formulations 60C, 88A, and 89C and further comparisons of 89C and an isotropic control.

The adhesive resin comprises: an acrylic or methacrylic oligomer blend which may optionally include monomer that adds mechanical features like “tack” and shear resistance to the resin, reactive diluents that improve contact between the resin and the capsule substrate, an optional adhesive promoter, photoinitiators that polymerize the other three components to produce the cured state, and conductive particles.

The resin is mixed with conductive particles below the percolation threshold (e.g., 0.1-20% by weight). Conductive particles may include carbon black, carbon nanotubes, graphite flakes, metal spheres, metal wires, metal flakes, metal-coated glass spheres, and metal-coated glass flakes. Metals used may consist of silver, gold, nickel, copper, or other conductive metals and their alloys. Metal particles may be made of one metal and coated in another. Sonication and/or dispersants may be used to improve dispersion quality.

After the resin is formulated, it is aligned and laminated. The liquid, mixed resin with particles is spread on a sheet of release film, either by a linear coater, by calendaring between two rollers, or by pressing two sheets of release together using a separator to set the thickness. An alternating electric field is applied to the particles to align them. The field may have a frequency between 100 Hz and 1 MHz. The electric field strength applied is between 0.4 and 10 MV/m. After the particles are aligned, a UV lamp is used to initiate curing of the resin. After curing, the adhesive is laminated onto the device backplane using heated rollers. Resin formulations are shown below.

### Example 1

Resin formulations of 60C, 88A, and 89C were prepared by combining the oligomer blend, reactive diluent, optional adhesion promoter, and 4.8% TPO/TPO-L in a single reactor using a planetary mixer. Prior to curing the resin is mixed with conductive particles and the conductive particles were dispersed with bath sonication (probe sonication will also work). The sonicated mixture was coated on a PET substrate with release and exposed to 365 nm UV using a commercial UV-LED source (ThermoFisher) in the presence of an 2 MV/m alternating electric field between two electrodes above and below the substrate. See Table 1 for formulations.

TABLE 1
Formulations of 60C, 88A, and 89C.

| Component | 60C | 88A | 89C |
|---|---|---|---|
| CN9073 | 66.7% | | |
| CN9018 | | 38.1% | 28.6% |
| CD9055 | 19% | | |
| SR9087 | 9.5% | | |
| SR256 | | 57.1% | |
| SR495B | | | 33.3% |
| Isobornyl Acrylate | | | 33.3% |
| TPO/TPO-L | 4.8% | 4.8% | 4.8% |

60C formulation combined the tin-free difunctional aliphatic urethane acrylate oligomer blend SARTOMER® CN9073 (66.7% by weight), alkoxylated phenol acrylate reactive diluent SARTOMER® SR9087 (9.5% by weight), acidic acrylate adhesive promoter SARTOMER® CD9055 (19% by weight) with 4.8% TPO/TPO-L. The resin of 60C may be mixed with 7-9 wt. % of silver-coated nickel flakes having an average size between 5-20 μm, 7-9 wt. % of graphite flakes having an average size between 10-30 μm, or 0.1-2 wt. % of carbon black.

88A formulation combined the aliphatic urethane acrylate oligomer blend SARTOMER® CN9018 (38.1% by weight), reactive diluent 2 (2-ethoxyethoxy)ethyl acrylate SARTOMER® SR256 (57.1% by weight), and 4.8% TPO/TPO-L. The resin of 88A may be mixed with 7-9 wt. % of silver-coated nickel flakes having an average size between 5-20 μm.

89C formulation combined the aliphatic urethane acrylate oligomer blend SARTOMER® CN9018 (28.6% by weight), reactive diluents SARTOMER® SR495B comprising caprolactone acrylate (33.3% by weight) and isobornyl acrylate (33.3% by weight), and 4.8% TPO/TPO-L.

The resin of 89C may be mixed with 7-9 wt. % of silver-coated nickel flakes having an average size between 5-20 μm.

It was found that the 89C formulation provided the best combination of tackiness (shear thickening rheology required for pressure-sensitive adhesives), resistivity in the lateral direction (i.e., along the substrate), and sufficient viscosity to keep the conductive particles from settling out between sonication, coating, and cure.

### Example 2

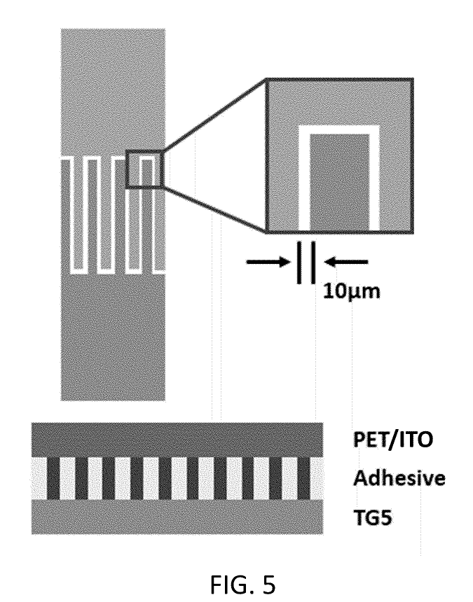

Impedance measurements were conducted for 89C. Impedance can be compared across adhesive types including resin alone, unaligned adhesive, and aligned adhesive. FIG. 5 illustrates lateral impedance across interdigitated electrodes.

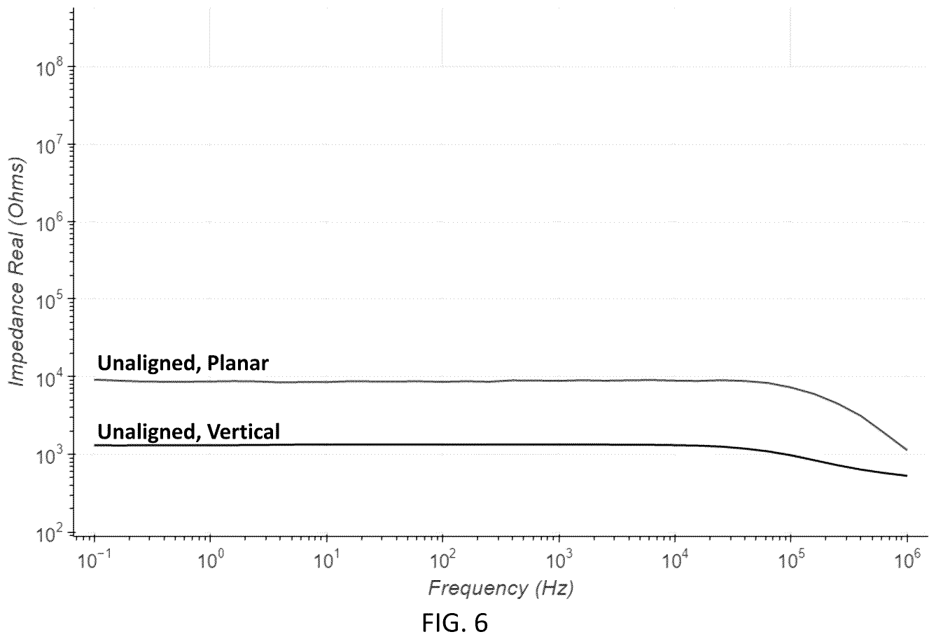

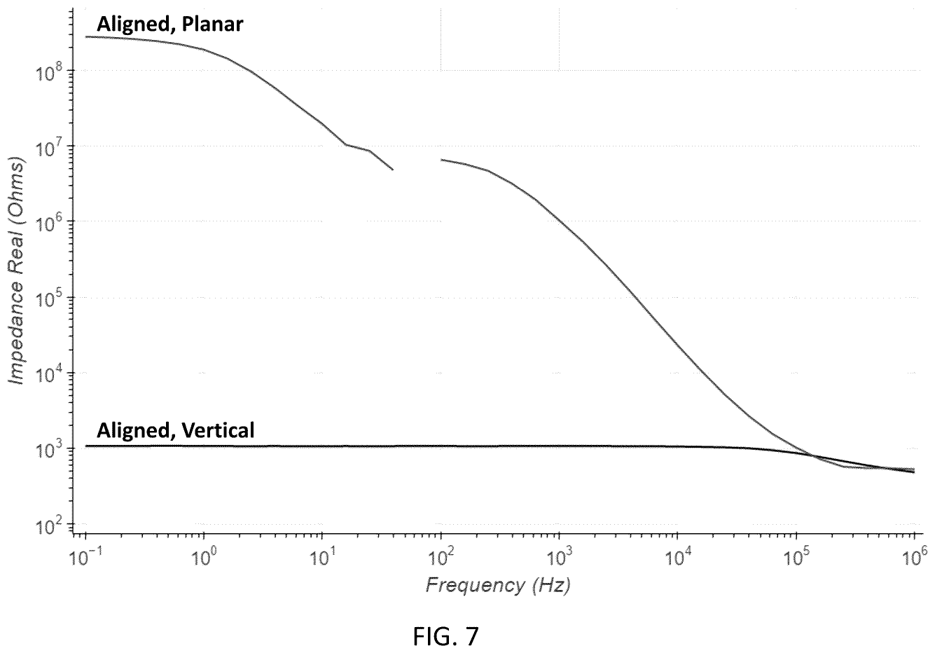

The unaligned impedance of sample 89C was measured both vertically and planar. (See FIG. 6.) The data for the adhesive resin 89C showed unaligned samples demonstrate high conductivity in both vertical and planar directions. The aligned impedance of sample 89C was also measured both vertically and planar as shown in FIG. 7. Aligned samples only showed high conductivity for vertical alignment. The planar aligned sample had a much lower conductivity. The highest conductivity observed was for the aligned, vertical sample shown in FIG. 7.

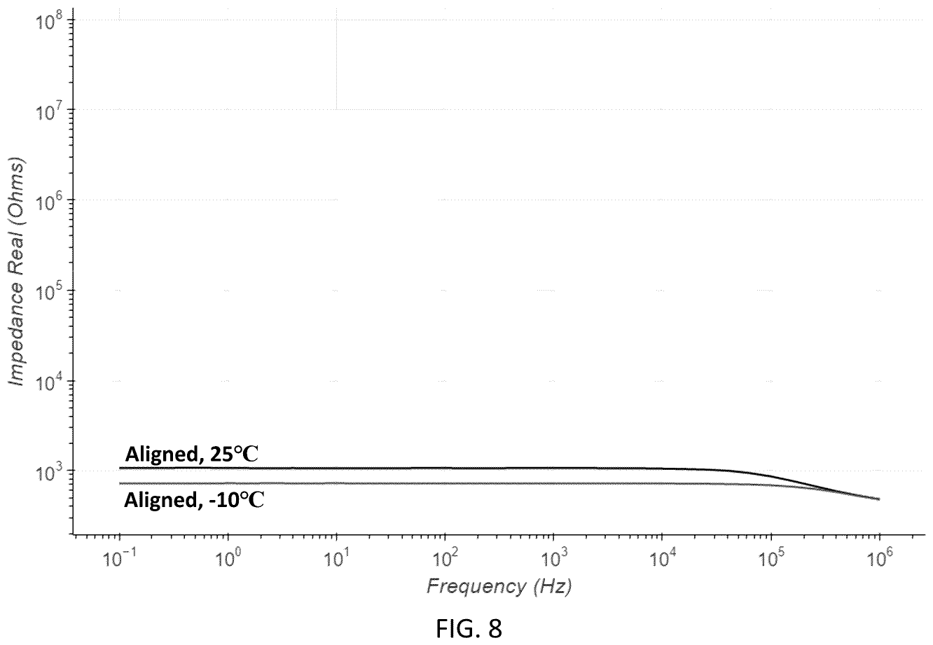

Because the aligned, vertical sample of 89C formulation showed the highest conductivity. A study of temperature effect on impedance was done at 25° C. and −10° C. as shown in FIG. 8. Little vertical temperature dependence was observed with the sample producing a high conductivity at both temperatures. Planar samples at varied temperature would be expected to vary as normal for resin.

### Example 3

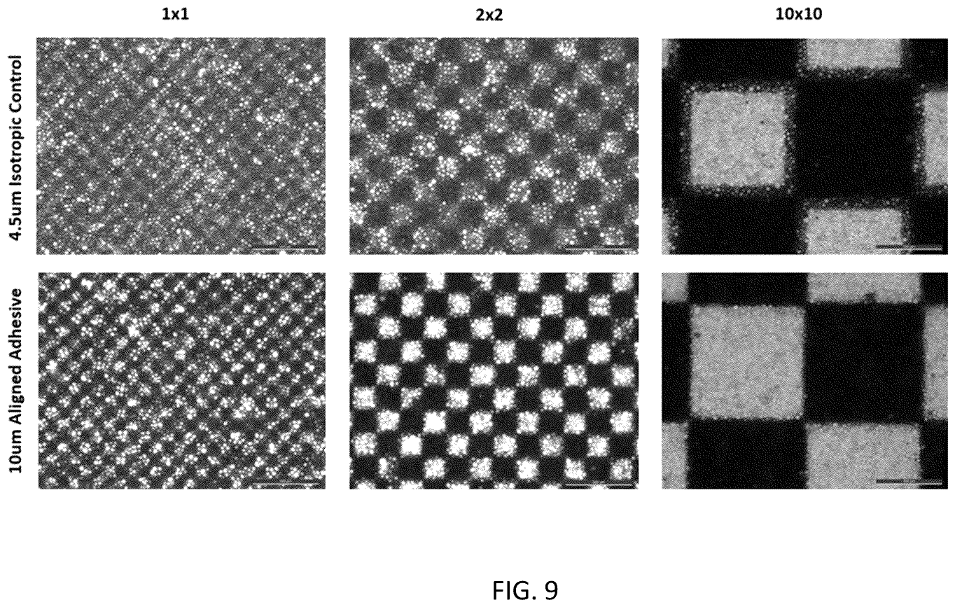

As the 89C formulation showed little vertical temperature dependence at 25° C. and −10° C., a blooming study of 89C at 65° C. was done to compare the stability of the 89C formulation to an isotropic control at an elevated temperature. FIG. 9 shows the blooming study at 1 pixel×1 pixel (left) 2 pixel×2 pixel (middle) and 10 pixel×10 pixel (right) for an isotropic control (top) compared to 89C (bottom). The blooming study showed the resulting resin of 89C is less temperature-dependent than the 4.5 μm isotropic control at 1 pixel×1 pixel, 2 pixel×2 pixel, and 10 pixel×10 pixel. Displays containing 89C for 10 pixel×10 pixel and 2 pixel×2 pixel show significantly improved uniformity compared to the 4.5 μm isotropic control.

1. A pressure-sensitive, anisotopically-conductive adhesive comprising a radiation-cured resin having aligned conductive particles therein,
wherein the pressure-sensitive, anisotropically-conductive adhesive has a higher electrical conductivity in a direction parallel to the aligned conductive particles than in a direction perpendicular to the aligned conductive particles,
wherein the resin prior to curing comprises:
(a) from 25-70% by wt. of one or more acrylic or methacrylic oligomers mixtures,
(b) from 5-70% by wt. of a reactive diluent,
(c) from 0-25% by wt. of an adhesion promoter; and
(d) an effective amount of a photoinitiator to initiate the curing of the resin when exposed to radiation, and
wherein the resin prior to curing is mixed with the conductive particles in an amount below a percolation threshold.

2. The pressure-sensitive, anisotopically-conductive adhesive of claim 1, wherein the resin prior to curing is mixed with 0.1-20% conductive particles by weight.

3. The pressure-sensitive, anisotopically-conductive adhesive of claim 1, wherein the conductive particles are selected from carbon black, carbon nanotubes, graphite flakes, metal spheres, metal wires, metal flakes, metal-coated glass spheres, metal-coated glass flakes, graphite microbeads, and any combination thereof.

4. The pressure-sensitive, anisotopically-conductive adhesive of claim 1, wherein the resin prior to curing comprises from 1-25% by wt. of the adhesion promoter.

5. The pressure-sensitive, anisotopically-conductive adhesive of claim 4, wherein the adhesion promoter comprises one or more acidic monomers or oligomers and/or one or more acid esters.

6. The pressure-sensitive, anisotopically-conductive adhesive of claim 5,
wherein the adhesion promoter comprises one or more acidic monomers or oligomers selected from acidic acrylates, acrylic acid, 2-carboxyethyl acrylate, and combinations thereof; anor
wherein the adhesion promoter comprises one or more acidic monomers or oligomers selected from 2-hydroxyethyl methacrylate phosphate in 2-(2-ethoxyethoxy)ethyl acrylate, 2-hydroxyethyl methacrylate phosphate in ethoxylated trimethylolpropane triacrylate, high entropy alloy phosphate in ethoxylated trimethylolpropane triacrylate, or an acid based adhesion promoter.

7. The pressure-sensitive, anisotopically-conductive adhesive of claim 1, wherein the one or more acrylic or methacrylic oligomers mixtures comprises aliphatic urethane acrylate, difunctional aliphatic urethane acrylate oligomer diluted with ethoxylated trimethylolpropane triacrylate, aliphatic urethane acrylate blended with isobornyl acrylate, tin-free aliphatic urethane acrylate, tin-free difunctional aliphatic urethane acrylate, low viscosity aliphatic urethane acrylate, tackifying acrylate, and combinations thereof.

8. The pressure-sensitive, anisotopically-conductive adhesive of claim 1, wherein the reactive diluent comprises 2(2-ethoxyethoxy)ethyl acrylate, 2-phenoxylethyl acrylate, 2-ethylhexyl acrylate, isodecyl acrylate, isooctyl acrylate, tridecyl acrylate, caprolactone acrylate, isobornyl acrylate, alkoxylated tetrahydrofurfuryl acrylates, alkoylated phenol acrylates, benzyl (meth)acrylate, phenoxylethyl (meth)acrylate, phenol (EO)ₙ acrylate, methoxy PEG methacrylate, nonyl phenol (EO)ₙ acrylate, nonyl phenol (PO)₂ acrylate, and cyclic trimethylolpropane formal acrylate (CTFA) and combinations thereof, wherein n is selected from 2, 4, 6, and 8.

9. The pressure-sensitive, anisotopically-conductive adhesive of claim 1, wherein the photoinitiator is TPO/TPO-L.

10. The pressure-sensitive, anisotopically-conductive adhesive of claim 1,
wherein the resin prior to curing is mixed with 0.1-20% conductive particles by weight;
wherein the conductive particles are selected from carbon black, carbon nanotubes, graphite flakes, metal spheres, metal wires, metal flakes, metal-coated glass spheres, metal-coated glass flakes, graphite microbeads, and any combination thereof;
wherein the one or more acrylic or methacrylic oligomers mixtures comprises, aliphatic urethane acrylate, difunctional aliphatic urethane acrylate oligomer diluted with ethoxylated trimethylolpropane triacrylate, aliphatic urethane acrylate blended with isobornyl acrylate, tin-free aliphatic urethane acrylate, tin-free difunctional aliphatic urethane acrylate, low viscosity aliphatic urethane acrylate, tackifying acrylate, and combinations thereof; and/or
wherein the reactive diluent comprises 2(2-ethoxyethoxy)ethyl acrylate, 2-phenoxylethyl acrylate, 2-ethylhexyl acrylate, isodecyl acrylate, isooctyl acrylate, tridecyl acrylate, caprolactone acrylate, isobornyl acrylate, alkoxylated tetrahydrofurfuryl acrylates, alkoylated phenol acrylates, benzyl (meth)acrylate, phenoxylethyl (meth)acrylate, phenol (EO)ₙ acrylate, methoxy PEG methacrylate, nonyl phenol (EO)ₙ acrylate, nonyl phenol (PO)₂ acrylate, and cyclic trimethylolpropane formal acrylate (CTFA) and combinations thereof, wherein n is selected from 2, 4, 6, and 8.

11. The pressure-sensitive, anisotopically-conductive adhesive of claim 10, wherein the resin prior to curing comprises from 1-25% by wt. of the adhesion promoter.

12. The pressure-sensitive, anisotopically-conductive adhesive of claim 11,
wherein the adhesion promoter comprises one or more acidic monomers or oligomers selected from acidic acrylates, acrylic acid, 2-carboxyethyl acrylate, and combinations thereof; or
wherein the adhesion promoter comprises one or more acidic monomers or oligomers selected from 2-hydroxyethyl methacrylate phosphate in 2-(2-ethoxyethoxy)ethyl acrylate, 2-hydroxyethyl methacrylate phosphate in ethoxylated trimethylolpropane triacrylate, high entropy alloy phosphate in ethoxylated trimethylolpropane triacrylate, or an acid based adhesion promoter.

13. The pressure-sensitive, anisotopically-conductive adhesive of claim 1,
wherein one or more acrylic or methacrylic oligomers mixtures comprise aliphatic urethane acrylate and
wherein the reactive diluent comprises caprolactone acrylate, isobornyl acrylate, 2(2-ethoxyethoxy)ethyl acrylate, or any combination thereof.

14. The pressure-sensitive, anisotopically-conductive adhesive of claim 13, wherein the resin comprises between 25-35% by wt. of the one or more acrylic or methacrylic oligomers mixtures; from 60-70% by wt. of the reactive diluent; and between 3-7% by wt. of the photoinitiator and/or wherein the resin prior to curing is mixed with 0.1-20% conductive particles by weight.

15. The pressure-sensitive, anisotopically-conductive adhesive of claim 1,
wherein one or more acrylic or methacrylic oligomers mixtures comprises tin-free difunctional aliphatic urethane acrylate;
wherein the reactive diluent comprises alkoxylated phenol acrylate; and
wherein the resin comprises the adhesion promoter acidic acrylates.

16. The pressure-sensitive, anisotopically-conductive adhesive of claim 15, wherein the resin comprises between 35-45% by wt. of the one or more acrylic or methacrylic oligomers mixtures; from 15-25% of the adhesion promoter; and from 55-65% by wt. of the reactive diluent; and between 3-7% by wt. of the photoinitiator and/or wherein the resin prior to curing is mixed with 0.1-20% conductive particles by weight.

17. An article for applying the pressure-sensitive, anisotopically-conductive adhesive according to claim 1, the article comprising the pressure-sensitive, anisotopically-conductive adhesive disposed on a first sheet of release film.

18. An article for applying the pressure-sensitive, anisotopically-conductive adhesive, wherein the article further comprises a second sheet of release film disposed on the pressure-sensitive, anisotopically-conductive adhesive opposite the first sheet of release film.

19. A display assembly comprising the pressure-sensitive, anisotopically-conductive adhesive of claim 1 disposed on a first substrate, wherein
the display assembly comprises a backplane assembly comprising the first substrate and a matrix of pixel electrodes defining individual pixels of a display; or
the display assembly comprises a frontplane assembly comprising the first substrate and a continuous electrode configured to extend across multiple pixels of a display.

20. The display assembly of claim 19, wherein the display assembly comprises a backplane assembly comprising the first substrate and a matrix of pixel electrodes defining individual pixels of a display, a frontplane assembly comprising the second substrate and a continuous electrode configured to extend across multiple pixels of a display, and the second substrate is disposed on the pressure-sensitive, anisotropically conductive adhesive opposite the first substrate.
